(19) United States
(12) Patent Application Publication
(10) Pub. No.: US 2025/0373314 A1
(43) Pub. Date: Dec. 4, 2025

(54) POWER SAVING AFTER BEAM FAILURE RECOVERY REQUEST

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/873,961

(22) PCT Filed: Aug. 26, 2022
(86) PCT No.: PCT/CN2022/115161

§ 371 Date: Dec. 11, 2024

(51) Int. Cl. H04B 7/06

(52) U.S. Cl. CPC H04B 7/06964; H04B 7/06956

(57) ABSTRACT

Various aspects of the present disclosure generally relate to wireless communication. In some aspects, a mobile station may detect a beam failure associated with a beam used to communicate with a network node. The mobile station may transmit a beam failure recovery (BFR) request to the network node based at least in part on the beam failure. The mobile station may refrain from monitoring one or more control channels associated with the beam failure after transmitting the BFR request. Numerous other aspects are described.

### FIELD OF THE DISCLOSURE

Aspects of the present disclosure generally relate to wireless communication and to techniques and apparatuses associated with power saving after a beam failure recovery (BFR) request.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a mobile station. The method may include detecting, by the mobile station, a beam failure associated with a beam used to communicate with a network node. The method may include transmitting, by the mobile station, a beam failure recovery (BFR) request to the network node based at least in part on the beam failure. The method may include refraining, by the mobile station, from monitoring one or more control channels associated with the beam failure after transmitting the BFR request.

Some aspects described herein relate to a mobile station for wireless communication. The mobile station may include a memory and one or more processors coupled to the memory. The one or more processors may be configured to detect a beam failure associated with a beam used to communicate with a network node. The one or more processors may be configured to transmit a BFR request to the network node based at least in part on the beam failure. The one or more processors may be configured to refrain from monitoring one or more control channels associated with the beam failure after transmitting the BFR request.

Some aspects described herein relate to a non-transitory computer-readable medium that stores a set of instructions for wireless communication by a mobile station. The set of instructions, when executed by one or more processors of the mobile station, may cause the mobile station to detect a beam failure associated with a beam used to communicate with a network node. The set of instructions, when executed by one or more processors of the mobile station, may cause the mobile station to transmit a BFR request to the network node based at least in part on the beam failure. The set of instructions, when executed by one or more processors of the mobile station, may cause the mobile station to refrain from monitoring one or more control channels associated with the beam failure after transmitting the BFR request.

Some aspects described herein relate to an apparatus for wireless communication. The apparatus may include means for detecting a beam failure associated with a beam used to communicate with a network node. The apparatus may include means for transmitting a BFR request to the network node based at least in part on the beam failure. The apparatus may include means for refraining from monitoring one or more control channels associated with the beam failure after transmitting the BFR request.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example resource structure for wireless communication, in accordance with the present disclosure.

FIG. 5 is a diagram illustrating an example of transmission reception point (TRP) differentiation at a UE based at least in part on a control resource set (CORESET) pool index, in accordance with the present disclosure.

FIG. 6 is a diagram illustrating examples of beam management procedures based on downlink reference signal transmissions, in accordance with the present disclosure.

FIG. 7 is a diagram illustrating an example associated with power saving after a beam failure recovery (BFR) request, in accordance with the present disclosure.

FIG. 8 is a diagram illustrating an example process associated with power saving after a BFR request, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

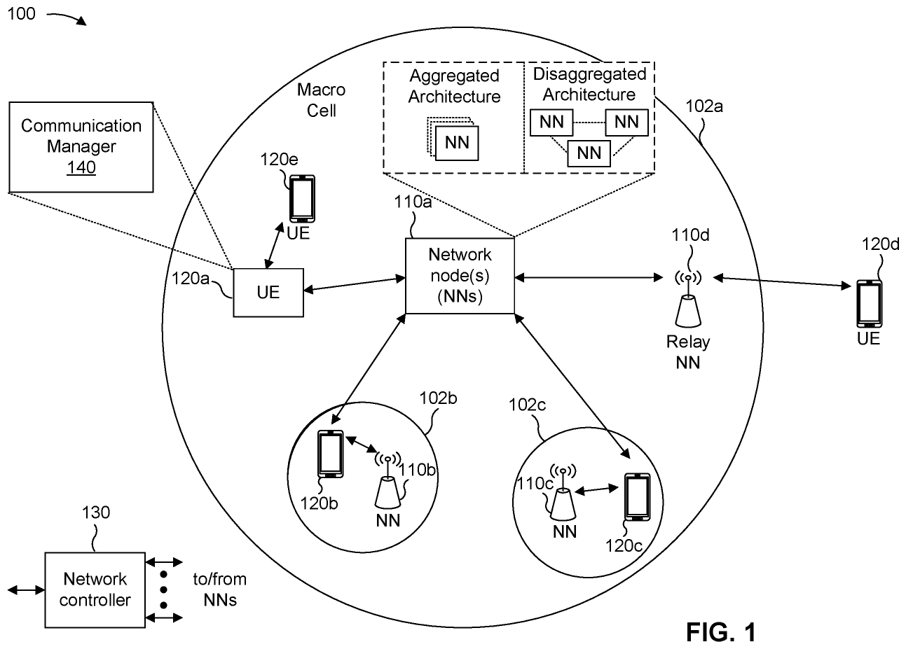

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, a “base station” or a “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may detect a beam failure associated with a beam used to communicate with a network node 110; transmit a beam failure recovery (BFR) request to the network node 110 based at least in part on the beam failure; and refrain from monitoring one or more control channels associated with the beam failure after transmitting the BFR request. Additionally, or alternatively, the communication manager 140 may perform one or more other operations described herein.

As indicated above, FIG. 1 is provided as an example. Other examples may differ from what is described with regard to FIG. 1.

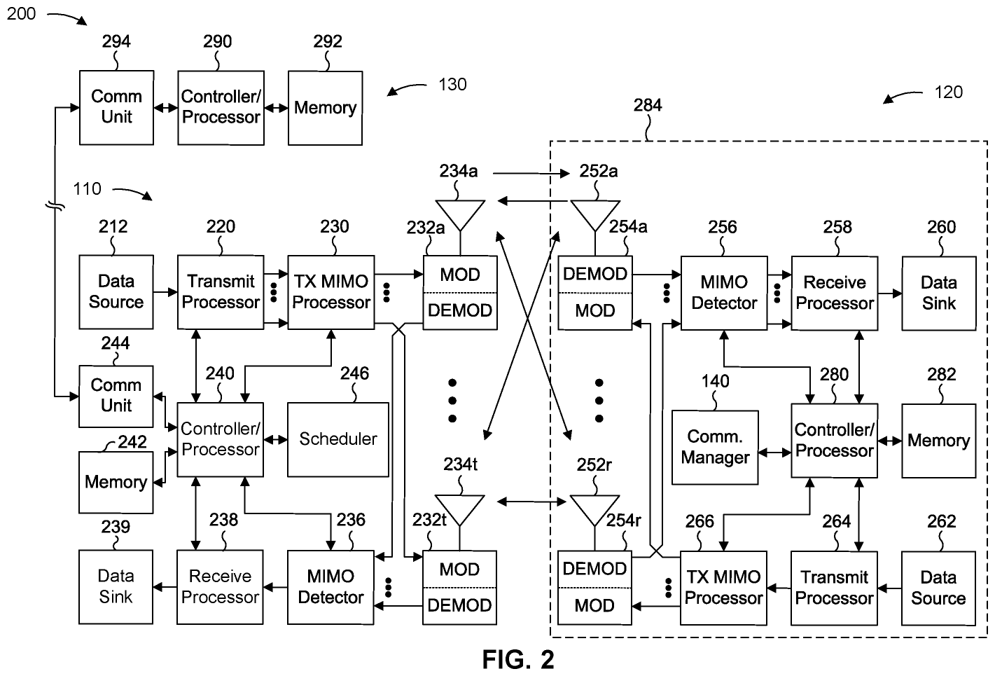

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

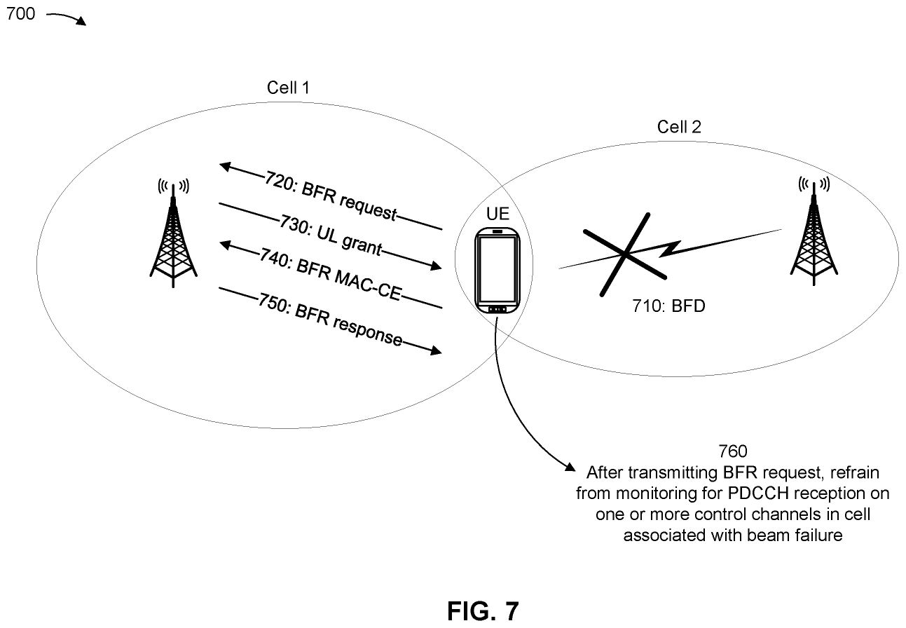

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-9).

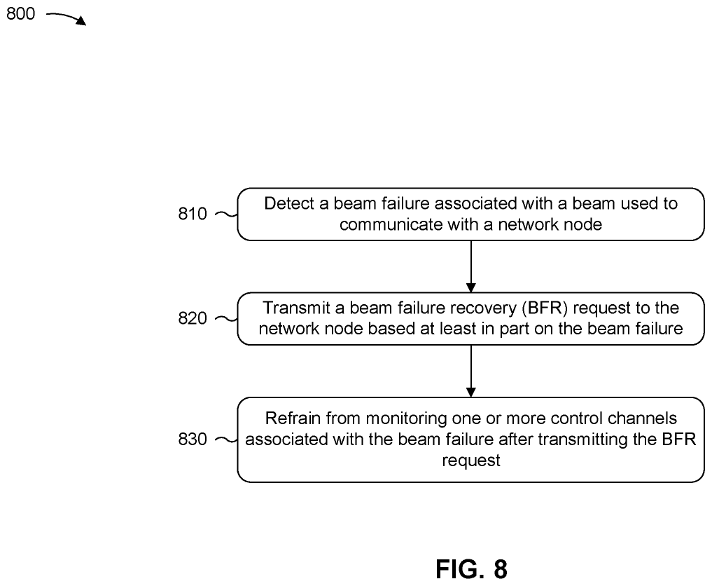

The controller/processor 240 of the network node 110, the controller/processor 280 of the UE 120, and/or any other component(s) of FIG. 2 may perform one or more techniques associated with power saving after a BFR request, as described in more detail elsewhere herein. In some aspects, a mobile station described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, a mobile station includes means for detecting a beam failure associated with a beam used to communicate with a network node 110; means for transmitting a BFR request to the network node 110 based at least in part on the beam failure; and/or means for refraining from monitoring one or more control channels associated with the beam failure after transmitting the BFR request. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

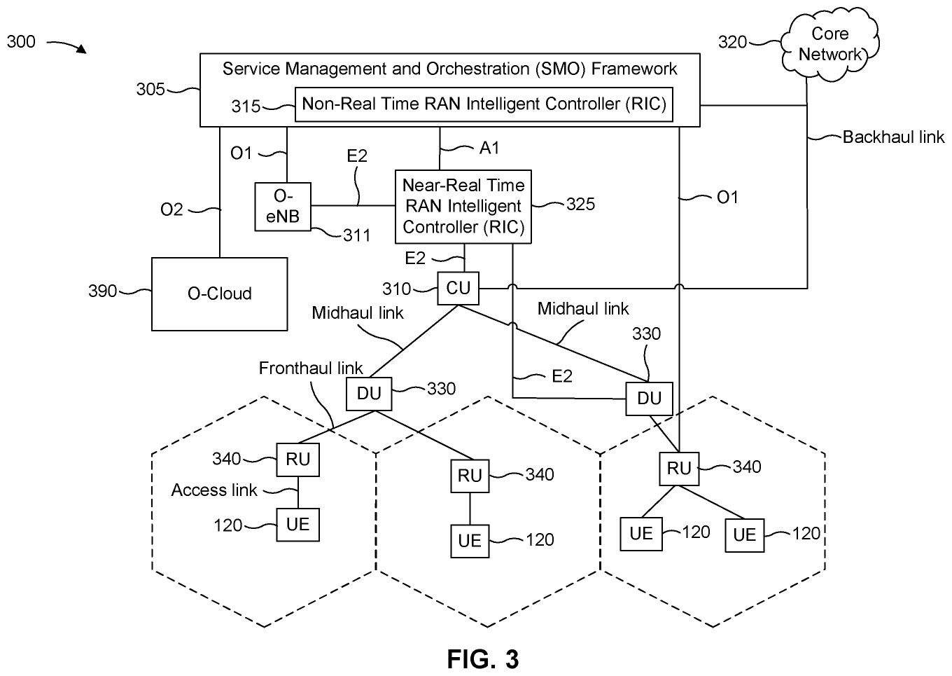

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

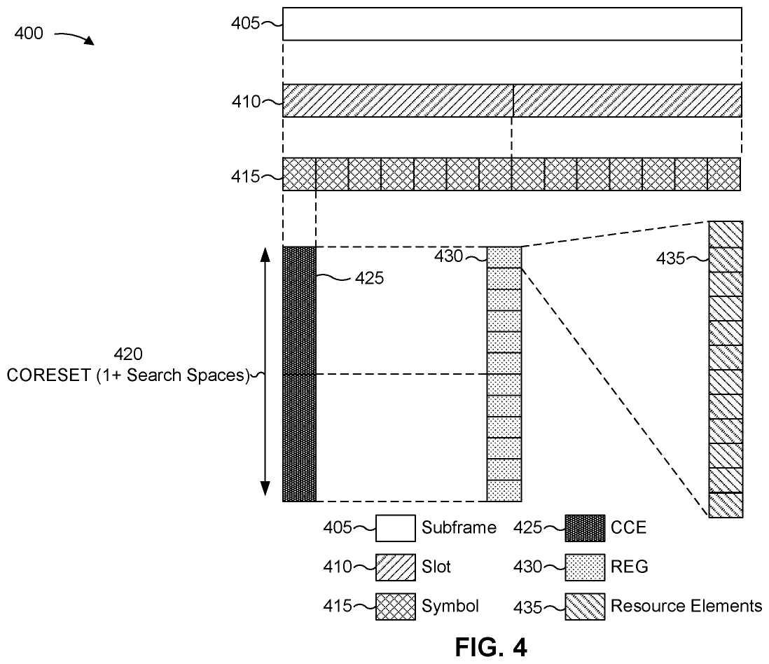

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a control resource set (CORESET) 420 and may be structured to support an efficient use of resources, such as by flexible configuration or reconfiguration of resources of the CORESET 420 for a physical downlink control channel (PDCCH) and/or a physical downlink shared channel (PDSCH). In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in a frequency domain, and either one, two, or three symbols 415 in a time domain. In a 5G network, a quantity of resources included in the CORESET 420 may be flexibly configured, such as by using RRC signaling to indicate a frequency domain region (e.g., a quantity of RBs) and/or a time domain region (e.g., a quantity of symbols) for the CORESET 420.

As illustrated, a symbol 415 that includes the CORESET 420 may include one or more control channel elements (CCEs) 425 (e.g., shown as two CCEs 425 in the illustrated example) that span a portion of the system bandwidth. A CCE 425 may include downlink control information (DCI) that is used to provide control information for wireless communication. A network node may transmit DCI in multiple CCEs 425 (e.g., as shown in FIG. 4), where the quantity of CCEs 425 used for transmission of the DCI represents an aggregation level (AL) used by the network node for the transmission of the DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as six REGs 430, or may include a variable quantity of REGs 430. In some aspects, the quantity of REGs 430 included in a CCE 425 may be specified by an REG bundle size. A REG 430 may include one RB, which may include 12 resource elements (REs) 435 within a symbol 415. An RE 435 may occupy one subcarrier in the frequency domain and one OFDM symbol in the time domain.

A search space may include all possible locations (e.g., in the time domain and/or the frequency domain) where a PDCCH may be located. A CORESET 420 may include one or more search spaces, such as a UE-specific search space, a group-common search space, a common search space, and/or a BFR search space, among other examples. A search space may indicate a set of CCE locations where a UE may find PDCCHs that can potentially carry control information transmitted to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in the time domain and/or the frequency domain) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have a CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

As indicated above, FIG. 4 is provided as an example. Other examples may differ from what is described with regard to FIG. 4.

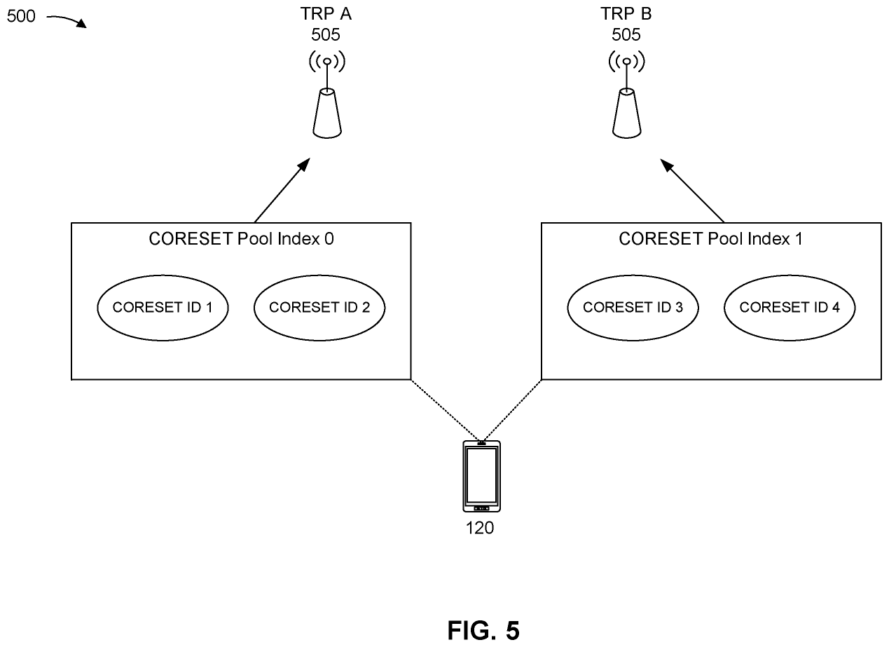

FIG. 5 is a diagram illustrating an example 500 of TRP differentiation at a UE based at least in part on a CORESET pool index, in accordance with the present disclosure. In some aspects, a CORESET pool index (or CORESETPoolIndex) value may be used by a UE (e.g., UE 120) to identify a TRP associated with an uplink grant received on a PDCCH. Additionally, or alternatively, in some aspects, the UE may use a CORESET group or a CORESET list value to identify a TRP associated with an uplink grant received on a PDCCH.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (e.g., up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP (mTRP) configuration, each CORESET pool index value may be associated with a particular TRP 505. As an example, and as illustrated in FIG. 5, a first TRP 505 (TRP A) (or a first network node 110, such as a first RU or a first DU associated with a CU) may be associated with CORESET pool index 0 and a second TRP 505 (TRP B) (or a second network node 110, such as a second RU or a second DU associated with the CU) may be associated with CORESET pool index 1. The UE 120 may be configured by a higher layer parameter, such as PD (CH-Config, with information identifying an association between a TRP 505 and a CORESET pool index value assigned to the TRP 505. Accordingly, the UE 120 may identify the TRP 505 that transmitted a DCI message carrying an uplink grant by determining the CORESET ID of the CORESET in which the PDCCH carrying the DCI message was transmitted, determining the CORESET pool index value associated with the CORESET pool in which the CORESET ID is included, and identifying the TRP 505 associated with the CORESET pool index value.

As indicated above, FIG. 5 is provided as an example. Other examples may differ from what is described with regard to FIG. 5.

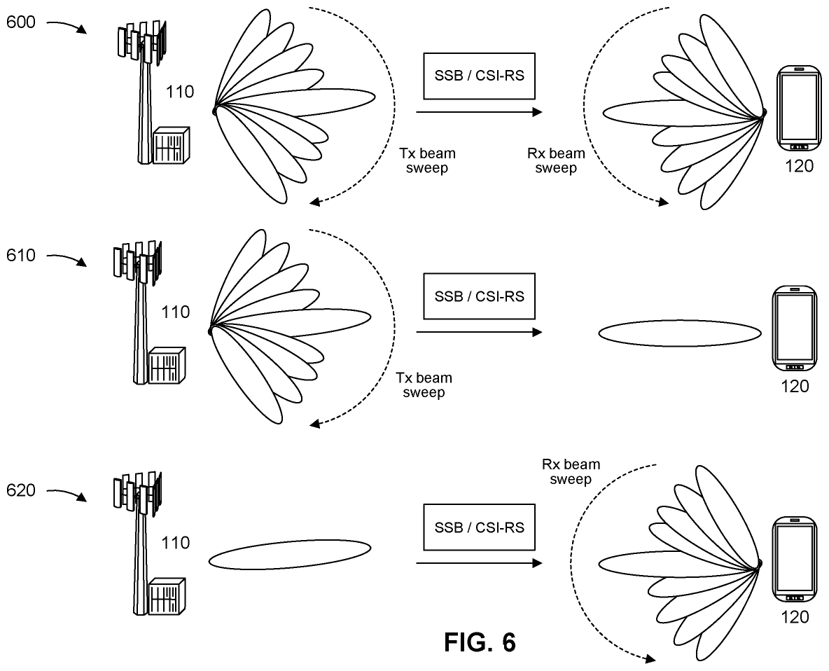

FIG. 6 is a diagram illustrating examples 600, 610, and 620 of beam management procedures based on downlink reference signal transmissions, in accordance with the present disclosure. As shown in FIG. 6, examples 600, 610, and 620 include a UE 120 in communication with a network node 110 in a wireless network (e.g., wireless network 100). However, the devices shown in FIG. 6 are provided as examples, and the wireless network may support communication and beam management between other devices (e.g., between a UE 120 and a TRP, a DU, or an RU, between a mobile termination node and a control node, between an IAB child node and an IAB parent node, and/or between a scheduled node and a scheduling node). In some aspects, the UE 120 and the network node 110 may be in a connected state (e.g., an RRC connected state) when performing the beam management procedure(s).

As shown in FIG. 6, example 600 may include the network node 110 and the UE 120 communicating to perform beam management using synchronization signal block (SSB) transmissions or channel state information reference signal (CSI-RS) transmissions. Example 600 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 6 and example 600, SSBs and/or CSI-RSs may be configured to be transmitted from the network node 110 to the UE 120 during the first beam management procedure. For example, an SSB transmitted by the network node 110 is a single rank (rank-1) periodic reference signal that is always transmitted by the network node 110 to enable initial network acquisition and synchronization in addition to beam selection and beam management. For example, an identifier associated with an SSB may have a one-to-one mapping to a transmit beam used by the network node 110, and the one-to-one mapping may be invariant (e.g., static) over time. Additionally, or alternatively, in cases where CSI-RS transmissions are used for the first beam management procedure, the CSI-RSs used for beam selection or beam management may be configured to be periodic (e.g., using RRC signaling), semi-persistent (e.g., using MAC control element (MAC-CE) signaling), and/or aperiodic (e.g., using DCI).

The first beam management procedure may include the network node 110 performing a beam sweep over multiple transmit (Tx) beams. The network node 110 may transmit an SSB or a CSI-RS using each transmit beam for beam management. To enable the UE 120 to perform receive (Rx) beam sweeping, the network node 110 may use a transmit beam to transmit (e.g., with repetitions) each SSB or CSI-RS at multiple times within the same reference signal resource set so that the UE 120 can perform a beam sweep over multiple receive beams in multiple transmission instances. For example, if the network node 110 has a set of N transmit beams and the UE 120 has a set of M receive beams, the SSB or CSI-RS may be transmitted on each of the N transmit beams M times such that the UE 120 may receive M instances of the SSB or CSI-RS per transmit beam. In other words, for each transmit beam of the network node 110, the UE 120 may perform a beam sweep through the receive beams of the UE 120. As a result, the first beam management procedure may enable the UE 120 to measure an SSB or CSI-RS on different transmit beams using different receive beams to support selection of one or more transmit/receive beam pair(s) (e.g., a pairing between a transmit beam of the network node 110 and a receive beam of the UE 120). The UE 120 may report the measurements to the network node 110 to enable the network node 110 to select one or more beam pairs for communication between the network node 110 and the UE 120.

As shown in FIG. 6, example 610 may include the network node 110 and the UE 120 communicating to perform beam management using SSB transmissions or CSI-RS transmissions. Example 610 depicts a second beam management procedure (e.g., P2 beam management). The second beam management procedure may be referred to as a beam refinement procedure, a base station beam refinement procedure, a network node beam refinement procedure, and/or a transmit beam refinement procedure, among other examples. As shown in FIG. 6 and example 610, SSBs and/or CSI-RSs may be configured to be transmitted from the network node 110 to the UE 120. The SSBs may be periodic, and the CSI-RSs may be configured to be aperiodic (e.g., using DCI). The second beam management procedure may include the network node 110 performing a beam sweep over one or more transmit beams. The one or more transmit beams may be a subset of all transmit beams associated with the network node 110 (e.g., determined based at least in part on measurements reported by the UE 120 in connection with the first beam management procedure). The network node 110 may transmit an SSB or a CSI-RS using each transmit beam of the one or more transmit beams for beam management. The UE 120 may measure each SSB or CSI-RS using a single (e.g., a same) receive beam (e.g., determined based at least in part on measurements performed in connection with the first beam management procedure). The second beam management procedure may enable the network node 110 to select a best transmit beam based at least in part on measurements of the SSBs and/or CSI-RSs (e.g., measured by the UE 120 using the single receive beam) reported by the UE 120.

As shown in FIG. 6, example 620 depicts a third beam management procedure (e.g., P3 beam management). The third beam management procedure may be referred to as a beam refinement procedure, a UE beam refinement procedure, a receive beam refinement procedure, and/or a UE beam management procedure, among other examples. As shown in FIG. 6 and example 620, one or more SSBs or CSI-RSs may be configured to be transmitted from the network node 110 to the UE 120. The SSBs may be configured to be periodic, and the CSI-RSs may be configured to be aperiodic (e.g., using DCI). The third beam management process may include the network node 110 transmitting the one or more SSBs or CSI-RSs using a single transmit beam (e.g., determined based at least in part on measurements reported by the UE 120 in connection with the first beam management procedure and/or the second beam management procedure). To enable the UE 120 to perform receive beam sweeping, the network node 110 may use a transmit beam to transmit (e.g., with repetitions) an SSB or CSI-RS at multiple times within the same reference signal resource set such that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the UE 120 to select a best receive beam based at least in part on measurements of the SSBs or CSI-RSs and/or may enable the network node 110 to select a best receive beam for the UE 120 based at least in part on reported measurements received from the UE 120 (e.g., measurements of the SSB and/or CSI-RS using the one or more receive beams).

In some cases, the UE 120 and the network node 110 may use beamforming to improve performance associated with downlink and/or uplink communication over a millimeter wave (mmW) channel. For example, a mmW channel (e.g., in FR2 and/or FR4) may suffer from high propagation loss because mmW signals have a higher frequency and a shorter wavelength than various other radio waves used for communications (e.g., sub-6 GHz communications in FR1). As a result, mmW signals often have shorter propagation distances, may be subject to atmospheric attenuation, and/or may be more easily blocked and/or subject to penetration loss through objects or other obstructions, among other examples. For example, a mmW signal may be reflected by lamp posts, vehicles, glass/windowpanes, and/or metallic objects, may be diffracted by edges or corners of buildings and/or walls, and/or may be scattered via irregular objects such as walls and/or human bodies (e.g., a hand blocking an antenna module when a device is operated in a gaming mode). Accordingly, beamforming may be used at both the UE 120 and the network node 110 to counter the propagation loss in a mmW channel and thereby improve performance for mmW communication. For example, to achieve a beamforming gain on a downlink, the network node 110 may generate a downlink transmit beam that is steered in a particular direction, and the UE 120 may generate a corresponding downlink receive beam. Similarly, to achieve a beamforming gain on an uplink, the UE 120 may generate an uplink transmit beam that is steered in a particular direction, and the network node 110 may generate a corresponding uplink receive beam. In some cases, the UE 120 may be permitted to select the downlink receive beam to optimize reception of a downlink transmission from the network node 110 and/or may be permitted to select the uplink transmit beam to optimize reception at the network node 110 for an uplink transmission by the UE 120.

However, in some cases (e.g., when the UE 120 is indoors or moving), a radio link between the UE 120 and the network node 110 may be susceptible to blockage and/or degradation, which may lead to a sudden interruption that results in beam failure. For example, radio link failure (RLF) occurs in a multi-beam scenario when radio problems within a cell cannot be solved by recovery procedures, or the UE 120 is unable to find any suitable beam to initiate a random access procedure and successfully recover the failed connection between the UE 120 and the network node 110. On the other hand, beam failure occurs when the UE 120 has lost a link via a current serving beam (e.g., based on a measurement associated with the current serving beam failing to satisfy a threshold) but the UE 120 is able to use another beam to perform a successful random access procedure to reestablish the (temporarily lost) connection with the network node 110. Accordingly, in some aspects, the UE 120 may be configured with one or more resources to enable beam failure detection, whereby the UE 120 may measure or detect sudden and rapid changes in a communication link and simultaneously recover the communication link to continue services. For example, the UE 120 may be configured to initiate a BFR procedure to select or otherwise configure a new serving beam based on processing at a PHY layer and a MAC layer without requiring any higher-layer (e.g., RRC) signaling.

As indicated above, FIG. 6 is provided as an example. Other examples may differ from what is described with regard to FIG. 6.

FIG. 7 is a diagram illustrating an example 700 associated with power saving after a BFR request, in accordance with the present disclosure. As shown in FIG. 7, a UE (e.g., UE 120) may connect to one or more cells, such as a first TRP and a second TRP in mTRP operation, a primary cell (PCell) and a secondary cell (SCell) using dual connectivity or carrier aggregation, or the like. For example, as described herein, a PCell may be a cell in which the UE either performs an initial connection establishment procedure or initiates a connection re-establishment procedure. For example, the PCell may handle signaling, such as RRC signaling, associated with the UE. In some aspects, the PCell may be a cell indicated as the primary cell during a handover procedure. The PCell may also be referred to as a special cell (SpCell). The SCell may be a cell that may be configured to provide additional radio resources to the UE. In some aspects, the PCell and the one or more SCells may each be considered serving cells. Similarly, different TRPs may each be considered serving cells (e.g., a first TRP may provide a PCell and a second TRP may provide an SCell). In some aspects, one SCell in a set of SCells may also handle signaling associated with the UE, and such an SCell may be referred to as a primary secondary cell (PSCell). A PSCell may be considered an SpCell. Accordingly, an SpCell may refer to a PCell of a master cell group or a PSCell of a secondary cell group. An SpCell is a cell on which a UE can transmit or receive control signaling, random access channel messages, or the like.

In example 700, the UE is associated with a first cell (shown as Cell 1) and a second cell (shown as Cell 2). For example, in some aspects, the first cell may be an SpCell (e.g., a PCell or a PSCell) and the second cell may be an SCell, the first cell may be a first SpCell (e.g., a PCell) and the second cell may be a second SpCell (e.g., a PSCell), or the like. In some aspects, the first cell may be in a first frequency range (FR) (e.g., FR1), and the second cell may be in a second FR (e.g., FR2). In some other aspects, the first cell and the second cell may be in the same FR. In some aspects, the first cell may be provided by a first network node (e.g., a first TRP), and the second cell may be provided by a second network node (e.g., a second TRP). In some other aspects, the first cell and the second cell may be provided by the same network node (e.g., a DU that controls multiple RUs, a CU that controls multiple DUs, or the like). In other words, example 700 is an example of a BFR procedure for a first cell and a second cell irrespective of whether the first cell and the second cell are provided by the same network node or different network nodes. Furthermore, although example 700 depicts a BFR procedure where the UE is communicating using multiple cells, it will be appreciated that similar techniques may be applied when the UE experiences beam failure in a single cell scenario (e.g., where the UE transmits a BFR request in the serving cell associated with the beam failure, rather than a different serving cell).

As shown in FIG. 7, and by reference number 710, the UE may detect a beam failure associated with a serving cell (e.g., cell 2 in the illustrated example). For example, the UE may detect that one or more downlink control beams have failed for the second cell, such as based at least in part on counting beam failure instances associated with the downlink control beams. Detecting that the one or more downlink control beams have failed may be referred to as beam failure detection (BFD). The UE (e.g., a MAC entity of the UE) may be configured, via RRC signaling, to trigger a BFR procedure when BFD occurs. For example, in some aspects, the BFR procedure may be configured per serving cell and may be used to indicate, to a serving network node, a new SSB or CSI-RS, such as via candidate beam information, when beam failure is detected on a serving beam (e.g., a serving SSB or a serving CSI-RS). For an SpCell BFR, the UE may initiate a random access channel (RACH) procedure for BFR.

As shown by reference number 720, the UE may transmit a BFR request (e.g., a scheduling request (SR) or a link recovery request (LRR)) on the first cell. Alternatively, in some aspects, the BFR request may be transmitted in the second cell associated with the detected beam failure (e.g., when there are one or more viable beams available to communicate with the cell associated with the beam failure). In some aspects, the BFR request may request a grant of uplink resources on which the UE can transmit a BFR MAC-CE that carries beam failure information. For example, in some aspects, the beam failure information carried in a BFR MAC-CE may indicate an identifier of the second cell (e.g., a failed serving cell instance), an indication of one or more beams that have failed, candidate beam information (e.g., information indicating one or more new candidate beams for BFR on the second cell), or the like. In some aspects, as described in more detail below, the UE may monitor one or more control channels after transmitting the BFR request. For example, as shown by reference number 730, the UE may receive an uplink grant on one or more control channels based at least in part on the BFR request, whereby the UE may monitor the one or more control channels to enable reception of a PDCCH that carries the uplink grant.

As shown by reference number 740, the UE may transmit a BFR MAC-CE after receiving the uplink grant. For example, the UE may transmit the BFR MAC-CE on an uplink resource indicated by the uplink grant. In some aspects, the UE may transmit the BFR MAC-CE based at least in part on evaluation of candidate beams for the second cell. For example, if the UE determines that at least one BFR has been triggered and not cancelled for a serving cell for which evaluation of candidate beams has been completed, and if uplink shared channel (UL-SCH) resources are available for a new transmission and if the UL-SCH resources can accommodate the BFR MAC-CE plus a subheader of the BFR MAC-CE as a result of logical channel prioritization (LCP), then the UE (e.g., via a multiplexing and assembly procedure of the UE) may generate the BFR MAC CE. If the UL-SCH resources cannot accommodate the BFR MAC-CE plus the subheader, UL-SCH resources are available for a new transmission, and the UL-SCH resources can accommodate a truncated BFR MAC-CE plus a subheader of the truncated BFR MAC-CE as a result of LCP, then the UE (e.g., via the multiplexing and assembly procedure) may generate the truncated BFR MAC CE. If neither of the above conditions is satisfied, the UE may trigger a scheduling request for beam failure recovery for each serving cell for which BFR has been triggered, not cancelled, and for which evaluation of the candidate beams has been completed. All BFRs triggered for a serving cell may be cancelled when a MAC protocol data unit (PDU) is transmitted and the MAC PDU includes a BFR MAC-CE or a truncated BFR MAC-CE that contains beam failure information of the serving cell associated with the beam failure. As shown by reference number 750, the UE may receive a BFR response, which may acknowledge reception of the BFR MAC-CE.

As mentioned above, after the UE transmits a BFR request to recover from a beam failure detected in a serving cell (e.g., to the serving cell associated with the beam failure or a different serving cell), the UE may monitor one or more control channels to enable reception of a PDCCH that carries an uplink grant indicating an uplink resource to be used to transmit BFR information (e.g., in a BFR MAC-CE). However, in some cases, the UE may continue to monitor one or more control channels that are associated with the failed beam after the beam failure has been detected. For example, in some cases, the UE may detect a beam failure in a serving cell (e.g., with respect to a serving beam used to communicate with a TRP, an SCell, a PCell, or a PSCell) and may continue to monitor one or more control channels associated with the serving cell even after the beam failure has been detected. However, continuing to monitor control channels associated with the beam that has already failed may result in wasted power consumption at the UE. Accordingly, some aspects described herein relate to techniques whereby a UE may refrain from monitoring one or more control channels after a BFR request has been transmitted to recover from a beam failure to save power. For example, as shown by reference number 760, the UE may refrain from monitoring for PDCCH reception on one or more control channels in a cell associated with a beam failure after transmitting the BFR request associated with the beam failure.

For example, in cases where the beam failure is detected in a serving cell provided by a TRP, the UE may be configured to refrain from monitoring one or more CORESETs that correspond to the TRP in the cell associated with the beam failure based at least in part on the BFR request not indicating a new candidate beam to be used to communicate with the TRP. For example, when the UE is configured to communicate with one or more TRPs (e.g., in an mTRP scenario), each TRP may provide a serving cell associated with a set of beam failure detection resources (e.g., resources that the UE is configured to measure to detect beam failure), which may be denoted q̅_{0,i} (where i is an index associated with a TRP), and a set of candidate beam identification resources, which may be denoted q̅_{1,i}. Accordingly, when the UE detects that the serving beam associated with a TRP has a radio link quality (e.g., an RSRP measurement or other suitable measurement) that fails to satisfy a threshold, the UE may attempt to identify a new candidate beam, which may be denoted q_{new}, from one or more CORESETs associated with the set of candidate beam identification resources, q̅_{1,i}. In general, when the UE is able to identify a new candidate beam that satisfies the applicable beam selection or beam recovery condition(s), the UE may indicate the new candidate beam in the BFR request and may assume antenna port quasi co-location (QCL) parameters corresponding to the new candidate beam after 28 symbols from a last symbol of a PDCCH reception with a DCI format scheduling a physical uplink shared channel (PUSCH) transmission that satisfies certain conditions (e.g., having the same hybrid automatic repeat request (HARQ) process number as a transmission of a second PUSCH and having a toggled new data indicator (NDI) field value). However, in some cases, the UE may be unable to identify any new candidate beam, q_{new}, from the set of candidate beam identification resources, q̅_{1,i}, associated with the TRP for which the beam failure was detected. In this case, because there is no suitable beam to resume communication with the TRP for which the beam failure was detected, the UE may refrain from monitoring (e.g., is not required to monitor) for PDCCH reception in the set of CORESETs associated with the TRP for which the beam failure was detected when the UE is unable to indicate a new candidate beam in the BFR request. In some examples, for serving cells associated with sets q̅_{0,0} and q̅_{1,0}, and with sets q̅_{0,1} and q̅_{1,1}, and having radio link quality worse than Q_{out,LR}, after 28 symbols from a last symbol of a first PDCCH reception with a DCI format scheduling a PUSCH transmission with a same HARQ process number as for transmission of the PUSCH carrying a MAC-CE of beam failure request and having a toggled NDI field value, the UE assumes antenna port QCL parameters: 1) corresponding to q_{new} from q̅_{1,0}, if any, for the first CORESETs; 2) corresponding to q_{new} from q̅_{1,1}, if any, for the second CORESETs, where the subcarrier spacing (SCS) configuration for the 28 symbols is the smallest of the SCS configurations of the active downlink bandwidth part for the PDCCH reception and of the active downlink bandwidth part(s) of the serving cells. If the UE is not able to provide any q_{new} from q̅_{1,0}, the UE is not required to monitor PDCCH on the first CORESETs. If the UE is not able to provide any q_{new} from q̅_{1,1}, the UE is not required to monitor PDCCH on the second CORESETs.

Additionally, or alternatively, in cases where the beam failure is detected in an SCell, the UE may be configured to refrain from monitoring one or more CORESETs in the SCell associated with the beam failure based at least in part on the BFR request not indicating a new candidate beam to be used to communicate in the SCell. For example, when the UE detects that a beam used to communicate in an SCell has a radio link quality that fails to satisfy a threshold, the UE may provide, in a first PUSCH transmission (e.g., the BFR request), an indication of a presence of a new candidate beam for the SCell and/or an index for a periodic CSI-RS configuration or an SSB for the corresponding SCell. In such cases, after a defined duration (e.g., 28 symbols) from a last symbol of a PDCCH reception with a DCI format scheduling a PUSCH transmission with the same HARQ process number as the transmission of the first PUSCH and having a toggled NDI field value, the UE may monitor a PDCCH in all CORESETs associated with the SCell using the same antenna port QCL parameters as the new candidate beam. However, in cases where the UE is unable to identify any new candidate beam, q_{new}, to re-establish communication with the SCell (e.g., the BFR request does not indicate a new candidate beam for the SCell), the UE may refrain from monitoring (e.g., is not required to monitor) for PDCCH reception in the one or more CORESETs associated with the SCell (e.g., to save power). For example, the UE can provide in a first PUSCH MAC-CE index(es) for at least corresponding SCell(s) with radio link quality worse than a threshold Q_{out,LR}, indication(s) of presence of qnew for corresponding SCell(s), and index(es) q_{new} for a periodic CSI-RS configuration or for a synchronization signal/physical broadcast channel (SS/PBCH) block provided by higher layers, if any, for corresponding SCell(s). After 28 symbols from a last symbol of a PDCCH reception with a DCI format scheduling a PUSCH transmission with a same HARQ process number as for the transmission of the first PUSCH and having a toggled NDI field value, the UE monitors PDCCH in all CORESETs on the SCell(s) indicated by the MAC-CE using the same antenna port QCL parameters as the ones associated with the corresponding index(es) q_{new}, if any. If the UE is not able to provide any q_{new}, the UE is not required to monitor PDCCH on the CORESETs.

Additionally, or alternatively, in cases where the beam failure is detected in an SpCell, which may include a PCell or a PSCell, the UE may be configured with a BFR CORESET via a link to a search space set (e.g., provided by a recoverySearchSpaceId parameter) for monitoring a PDCCH in the BFR CORESET. In general, in cases where the UE is provided or otherwise configured with the BFR CORESET (e.g., via the search space set provided for BFR), the UE does not expect to be provided with another search space set for monitoring the PDCCH in the BFR CORESET associated with the search space set provided for BFR. After the BFR request, the UE does not need to monitor other CORESET except the CORESET associated with the recoverySearchSpaceId parameter. Accordingly, when the beam failure is detected in a PCell or a PSCell, the UE may monitor only the BFR CORESET after transmitting the BFR request, and the UE may refrain from monitoring (e.g., does not need to or is not required to monitor) CORESETs other than the BFR CORESET associated with the search space set provided for BFR in order to save power.

As indicated above, FIG. 7 is provided as an example. Other examples may differ from what is described with regard to FIG. 7.

FIG. 8 is a diagram illustrating an example process 800 performed, for example, by a mobile station, in accordance with the present disclosure. Example process 800 is an example where the mobile station (e.g., UE 120) performs operations associated with power saving after a BFR request.

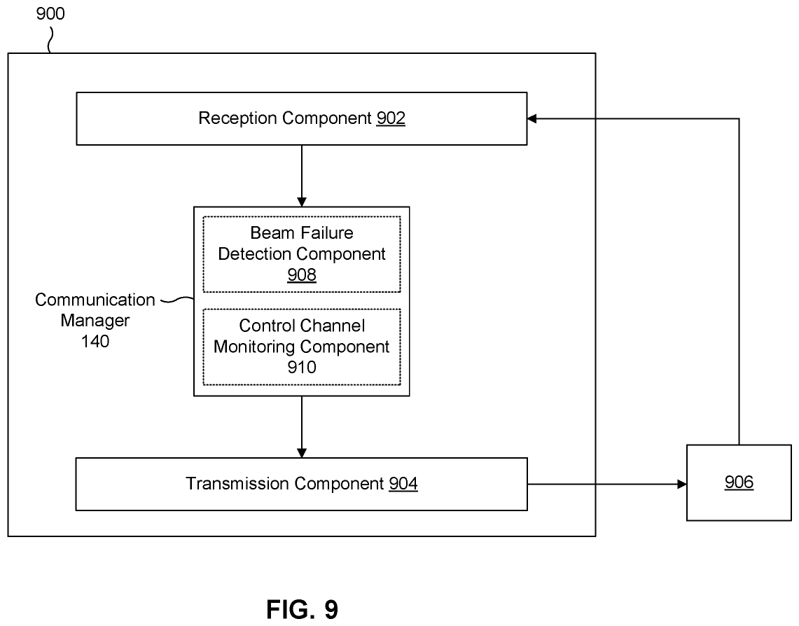

As shown in FIG. 8, in some aspects, process 800 may include detecting a beam failure associated with a beam used to communicate with a network node (block 810). For example, the mobile station (e.g., using communication manager 140 and/or beam failure detection component 908, depicted in FIG. 9) may detect a beam failure associated with a beam used to communicate with a network node, as described above.

As further shown in FIG. 8, in some aspects, process 800 may include transmitting a BFR request to the network node based at least in part on the beam failure (block 820). For example, the mobile station (e.g., using communication manager 140 and/or transmission component 904, depicted in FIG. 9) may transmit a BFR request to the network node based at least in part on the beam failure, as described above.

As further shown in FIG. 8, in some aspects, process 800 may include refraining from monitoring one or more control channels associated with the beam failure after transmitting the BFR request (block 830). For example, the mobile station (e.g., using communication manager 140 and/or control channel monitoring component 910, depicted in FIG. 9) may refrain from monitoring one or more control channels associated with the beam failure after transmitting the BFR request, as described above.

Process 800 may include additional aspects, such as any single aspect or any combination of aspects described below and/or in connection with one or more other processes described elsewhere herein.

In a first aspect, the beam associated with the beam failure is a beam used to communicate with a TRP associated with the network node.

In a second aspect, alone or in combination with the first aspect, the one or more control channels comprise CORESETs associated with the TRP based at least in part on the BFR request not indicating a new candidate beam to use to communicate with the TRP.

In a third aspect, alone or in combination with one or more of the first and second aspects, the beam associated with the beam failure is a beam used to communicate with the network node in an SCell.

In a fourth aspect, alone or in combination with one or more of the first through third aspects, the one or more control channels comprise CORESETs associated with the SCell based at least in part on the BFR request not indicating a new candidate beam to use to communicate in the SCell.

In a fifth aspect, alone or in combination with one or more of the first through fourth aspects, the beam associated with the beam failure is a beam used to communicate with the network node in a PCell or a PSCell.

In a sixth aspect, alone or in combination with one or more of the first through fifth aspects, the one or more control channels comprise CORESETs associated with the PCell or the PSCell other than a CORESET associated with a BFR search space set.

In a seventh aspect, alone or in combination with one or more of the first through sixth aspects, process 800 includes monitoring, by the mobile station, the CORESET associated with the BFR search space set after transmitting the BFR request.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a beam failure detection component 908 or a control channel monitoring component 910, among other examples.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The beam failure detection component 908 may detect a beam failure associated with a beam used to communicate with a network node. The transmission component 904 may transmit a BFR request to the network node based at least in part on the beam failure. The control channel monitoring component 910 may refrain from monitoring one or more control channels associated with the beam failure after transmitting the BFR request.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a mobile station, comprising: detecting, by the mobile station, a beam failure associated with a beam used to communicate with a network node; transmitting, by the mobile station, a BFR request to the network node based at least in part on the beam failure; and refraining, by the mobile station, from monitoring one or more control channels associated with the beam failure after transmitting the BFR request.

Aspect 2: The method of Aspect 1, wherein the beam associated with the beam failure is a beam used to communicate with a TRP associated with the network node.

Aspect 3: The method of Aspect 2, wherein the one or more control channels comprise CORESETs associated with the TRP based at least in part on the BFR request not indicating a new candidate beam to use to communicate with the TRP.

Aspect 4: The method of any of Aspects 1-3, wherein the beam associated with the beam failure is a beam used to communicate with the network node in an SCell.

Aspect 5: The method of Aspect 4, wherein the one or more control channels comprise CORESETs associated with the SCell based at least in part on the BFR request not indicating a new candidate beam to use to communicate in the SCell.

Aspect 6: The method of any of Aspects 1-3, wherein the beam associated with the beam failure is a beam used to communicate with the network node in a PCell or a PSCell.

Aspect 7: The method of Aspect 6, wherein the one or more control channels comprise CORESETs associated with the PCell or the PSCell other than a CORESET associated with a BFR search space set.

Aspect 8: The method of Aspect 7, further comprising: monitoring, by the mobile station, the CORESET associated with the BFR search space set after transmitting the BFR request.

Aspect 9: An apparatus for wireless communication at a device, comprising a processor; memory coupled with the processor; and instructions stored in the memory and executable by the processor to cause the apparatus to perform the method of one or more of Aspects 1-8.

Aspect 10: A device for wireless communication, comprising a memory and one or more processors coupled to the memory, the one or more processors configured to perform the method of one or more of Aspects 1-8.

Aspect 11: An apparatus for wireless communication, comprising at least one means for performing the method of one or more of Aspects 1-8.

Aspect 12: A non-transitory computer-readable medium storing code for wireless communication, the code comprising instructions executable by a processor to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a mobile station, comprising:
detecting, by the mobile station, a beam failure associated with a beam used to communicate with a network node;
transmitting, by the mobile station, a beam failure recovery (BFR) request to the network node based at least in part on the beam failure; and
refraining, by the mobile station, from monitoring one or more control channels associated with the beam failure after transmitting the BFR request.

2. The method of claim 1, wherein the beam associated with the beam failure is a beam used to communicate with a transmission reception point (TRP) associated with the network node.

3. The method of claim 2, wherein the one or more control channels comprise control resource sets (CORESETs) associated with the TRP based at least in part on the BFR request not indicating a new candidate beam to use to communicate with the TRP.

4. The method of claim 1, wherein the beam associated with the beam failure is a beam used to communicate with the network node in a secondary cell (SCell).

5. The method of claim 4, wherein the one or more control channels comprise control resource sets (CORESETs) associated with the SCell based at least in part on the BFR request not indicating a new candidate beam to use to communicate in the SCell.

6. The method of claim 1, wherein the beam associated with the beam failure is a beam used to communicate with the network node in a primary cell (PCell) or a primary secondary cell (PSCell).

7. The method of claim 6, wherein the one or more control channels comprise control resource sets (CORESETs) associated with the PCell or the PSCell other than a CORESET associated with a BFR search space set.

8. The method of claim 7, further comprising:
monitoring, by the mobile station, the CORESET associated with the BFR search space set after transmitting the BFR request.

9. A mobile station for wireless communication, comprising:
a memory; and
one or more processors, coupled to the memory and based at least in part on information stored in the memory, configured to:
detect a beam failure associated with a beam used to communicate with a network node;
transmit a beam failure recovery (BFR) request to the network node based at least in part on the beam failure; and
refrain from monitoring one or more control channels associated with the beam failure after transmitting the BFR request.

10. The mobile station of claim 9, wherein the beam associated with the beam failure is a beam used to communicate with a transmission reception point (TRP) associated with the network node.

11. The mobile station of claim 10, wherein the one or more control channels comprise control resource sets (CORESETs) associated with the TRP based at least in part on the BFR request not indicating a new candidate beam to use to communicate with the TRP.

12. The mobile station of claim 9, wherein the beam associated with the beam failure is a beam used to communicate with the network node in a secondary cell (SCell).

13. The mobile station of claim 12, wherein the one or more control channels comprise control resource sets (CORESETs) associated with the SCell based at least in part on the BFR request not indicating a new candidate beam to use to communicate in the SCell.

14. The mobile station of claim 9, wherein the beam associated with the beam failure is a beam used to communicate with the network node in a primary cell (PCell) or a primary secondary cell (PSCell).

15. The mobile station of claim 14, wherein the one or more control channels comprise control resource sets (CORESETs) associated with the PCell or the PSCell other than a CORESET associated with a BFR search space set.

16. The mobile station of claim 15, wherein the one or more processors are further configured to:
monitor the CORESET associated with the BFR search space set after transmitting the BFR request.

17. A non-transitory computer-readable medium storing a set of instructions for wireless communication, the set of instructions comprising:
one or more instructions that, when executed by one or more processors of a mobile station, cause the mobile station to:
detect a beam failure associated with a beam used to communicate with a network node;
transmit a beam failure recovery (BFR) request to the network node based at least in part on the beam failure; and
refrain from monitoring one or more control channels associated with the beam failure after transmitting the BFR request.

18. The non-transitory computer-readable medium of claim 17, wherein the beam associated with the beam failure is a beam used to communicate with a transmission reception point (TRP) associated with the network node.

19. The non-transitory computer-readable medium of claim 18, wherein the one or more control channels comprise control resource sets (CORESETs) associated with the TRP based at least in part on the BFR request not indicating a new candidate beam to use to communicate with the TRP.

20. The non-transitory computer-readable medium of claim 17, wherein the beam associated with the beam failure is a beam used to communicate with the network node in a secondary cell (SCell).

21. The non-transitory computer-readable medium of claim 20, wherein the one or more control channels comprise control resource sets (CORESETs) associated with the SCell based at least in part on the BFR request not indicating a new candidate beam to use to communicate in the SCell.

22. The non-transitory computer-readable medium of claim 17, wherein the beam associated with the beam failure is a beam used to communicate with the network node in a primary cell (PCell) or a primary secondary cell (PSCell).

23. The non-transitory computer-readable medium of claim 22, wherein the one or more control channels comprise control resource sets (CORESETs) associated with the PCell or the PSCell other than a CORESET associated with a BFR search space set.

24. The non-transitory computer-readable medium of claim 23, wherein the one or more instructions further cause the mobile station to:
monitor the CORESET associated with the BFR search space set after transmitting the BFR request.

25. An apparatus for wireless communication, comprising:
means for detecting a beam failure associated with a beam used to communicate with a network node;
means for transmitting a beam failure recovery (BFR) request to the network node based at least in part on the beam failure; and
means for refraining from monitoring one or more control channels associated with the beam failure after transmitting the BFR request.

26. The apparatus of claim 25, wherein the beam associated with the beam failure is a beam used to communicate with a transmission reception point (TRP) associated with the network node.

27. The apparatus of claim 26, wherein the one or more control channels comprise control resource sets (CORESETs) associated with the TRP based at least in part on the BFR request not indicating a new candidate beam to use to communicate with the TRP.

28. The apparatus of claim 25, wherein the beam associated with the beam failure is a beam used to communicate with the network node in a secondary cell (SCell).

29. The apparatus of claim 28, wherein the one or more control channels comprise control resource sets (CORESETs) associated with the SCell based at least in part on the BFR request not indicating a new candidate beam to use to communicate in the SCell.

30. The apparatus of claim 25, wherein the beam associated with the beam failure is a beam used to communicate with the network node in a primary cell (PCell) or a primary secondary cell (PSCell).

31. The apparatus of claim 30, wherein the one or more control channels comprise control resource sets (CORESETs) associated with the PCell or the PSCell other than a CORESET associated with a BFR search space set.

32. The apparatus of claim 31, further comprising:
means for monitoring the CORESET associated with the BFR search space set after transmitting the BFR request.
